(19) United States
(12) Patent Application Publication
(10) Pub. No.: US 2024/0289126 A1
(43) Pub. Date: Aug. 29, 2024

(54) REFACTORING CODE USING A MACHINE LEARNING MODEL

(71) Applicant: International Business Machines Corporation, Armonk, NY (US)

(72) Inventors: Julian Timothy Dolby, Bronx, NY (US); Kiran A. Kate, Chappaqua, NY (US); Martin Hirzel, Chappaqua, NY (US); Jason Tsay, White Plains, NY (US); Kavitha Srinivas, Port Chester, NY (US)

(21) Appl. No.: 18/113,291

(22) Filed: Feb. 23, 2023

(51) Int. Cl. G06F 8/72; G06F 8/41; G06N 3/08

(52) U.S. Cl. CPC G06F 8/72; G06F 8/447; G06N 3/08

(57) ABSTRACT

A computer-implemented method, system and computer program product for refactoring code using a machine learning model. Parallel corpora is generated using a single directional code transform. A single directional code transform refers to a transformation performed by a refactoring tool which refactors computer code (“code”) to restructure the code to include styles, which are often undesirable, such as “for” loops. Parallel corpora refers to a collection of code of a first style of code (e.g., dictionary comprehensions) in the code prior to refactoring (non-refactored code) and a second style of code (e.g., “for” loops) in the refactored code. A machine learning model is then trained to perform code refactoring in a reverse direction of the single directional code transform using the parallel corpora. New computer code is then refactored using the trained machine learning model, where the refactored code now includes a desired style of code (e.g., dictionary comprehensions).

### TECHNICAL FIELD

The present disclosure relates generally to code refactoring, and more particularly to refactoring computer code using a machine learning model (e.g., neural network model).

### BACKGROUND

Code refactoring is the process of restructuring existing computer code-changing the factoring-without changing its external behavior. Refactoring is intended to improve the design, structure and/or implementation of the software (its non-functional attributes) while preserving its functionality. Potential advantages of refactoring include improving the code readability and reducing complexity. Furthermore, refactoring may improve the source code's maintainability and create a simpler, cleaner or more expressive internal architecture or object model to improve extensibility. Another potential advantage of refactoring is improved performance. Software engineers face an ongoing challenge to write programs that perform faster or use less memory.

### SUMMARY

In one embodiment of the present disclosure, a computer-implemented method for refactoring code using a machine learning model comprises generating parallel corpora using a single directional code transform, where the parallel corpora contains a collection of code of a first style of code and translation of the collection of code of the first style of code into a second style of code. The method further comprises training the machine learning model to perform code refactoring in a reverse direction of the single directional code transform using the parallel corpora. The method additionally comprises performing code refactoring on computer code producing refactored code using the trained machine learning model.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the refactoring mechanism to refactor code using a machine learning model to restructure the code to include desired styles in accordance with an embodiment of the present disclosure;

FIG. 3 illustrates parallel corpora that consists of a list comprehension (first style) in the code that was transformed into a “for” loop in the refactored code (second style) in accordance with an embodiment of the present disclosure;

FIG. 4 illustrates a masked token used in a first style of code of the refactored code that the machine learning model is trained to predict in a second style of code of the non-refactored code based on the context surrounding the masked token in accordance with an embodiment of the present disclosure;

FIG. 5 illustrates an embodiment of the present disclosure of the hardware configuration of the refactoring mechanism which is representative of a hardware environment for practicing the present disclosure;

FIG. 6 is a flowchart of a method for training a machine learning model to perform code refactoring in a reverse direction of a single directional code transform in accordance with an embodiment of the present disclosure; and

FIG. 7 is a flowchart of a method for refactoring code using the trained machine learning model to generate desired styles in the refactored code in accordance with an embodiment of the present disclosure.

### DETAILED DESCRIPTION

As stated above, code refactoring is the process of restructuring existing computer code changing the factoring-without changing its external behavior. Refactoring is intended to improve the design, structure and/or implementation of the software (its non-functional attributes) while preserving its functionality. Potential advantages of refactoring include improving the code readability and reducing complexity. Furthermore, refactoring may improve the source code's maintainability and create a simpler, cleaner or more expressive internal architecture or object model to improve extensibility. Another potential advantage of refactoring is improved performance. Software engineers face an ongoing challenge to write programs that perform faster or use less memory.

Typically, refactoring applies a series of standardized basic micro-refactorings, each of which is usually a tiny change in a computer program's source code that either preserves the behavior of the software or at least does not modify its conformance to functional requirements. Many development environments provide automated support for performing the mechanical aspects of these basic refactorings. If done well, code refactoring may help software developers discover and fix hidden or dormant bugs or vulnerabilities in the system by simplifying the underlying logic and eliminating unnecessary levels of complexity.

As computer programming has evolved, certain styles of code have become more desirable than other styles of code, such as due to improving the code readability and reducing complexity. For example, it has become more desirable to use list comprehensions (syntactic construct available for creating a list based on existing lists) or dictionary comprehensions (method for transforming one dictionary into another dictionary) rather than “for” loops (used to repeat a specific block of code a known number of times). In another example, it has become more desirable to use generators (routine that can be used to control the iteration behavior of a loop) for efficient handling of code. In a further example, it has become more desirable to use typing annotations (used to indicate the datatypes of variables and input/outputs of functions and methods), especially in dynamically typed languages (the type of a variable is allowed to change over its lifetime). In another example, it has become more desirable to use lambda functions (blocks of code that can be assigned to variables, passed as an argument or returned from a function call in languages that support high-order functions) instead of defined functions (relation between a set of inputs having one output each).

Unfortunately, many of these desired styles are difficult for refactoring tools to generate when refactoring code, especially in dynamically typed languages.

The embodiments of the present disclosure provide a means for generating such desired styles when refactoring code by utilizing a trained machine learning model (e.g., neural network model) to generate such desired styles when refactoring code. In one embodiment, parallel corpora is generated using a single directional code transform, such as transforming list comprehensions or dictionary comprehensions to “for” loops, transforming typed annotations to no annotations and transforming lambda functions to defined or named functions. A “parallel corpora,” as used herein, refers to a collection of code of a first style of code (e.g., dictionary comprehensions) and a second style of code (e.g., “for” loops). Such transformations are performed using rule-based approaches when refactoring code, which are easier to perform than the reverse direction. Since such transformations when refactoring code may restructure the code to include non-desired styles (e.g., “for” loops as opposed to dictionary comprehensions), the principles of the present disclosure train a machine learning model (e.g., neural network model) to refactor code in the reverse direction (e.g., transforming “for” loops to dictionary comprehensions) using parallel corpora, which includes both styles of code. After training the machine learning model (e.g., neural network model) to refactor code to restructure the code to include desired styles from non-desired styles, new computer code may be refactored using such a trained machine learning model to restructure the code to include desired styles. A further discussion regarding these and other features is provided below.

In some embodiments of the present disclosure, the present disclosure comprises a computer-implemented method, system and computer program product for refactoring code using a machine learning model. In one embodiment of the present disclosure, parallel corpora is generated using a single directional code transform. A “single directional code transform,” as used herein, refers to a transformation performed by a refactoring tool which refactors computer code (“code”) to restructure the code to include styles, which are often undesirable, such as “for” loops, named or defined functions, excluding annotations, etc. Such code is often restructured to include undesirable styles by current refactoring tools due to the ease in restructuring the code to include such undesirable styles. “Parallel corpora,” as used herein, refers to a collection of code of a first style of code (e.g., dictionary comprehensions) in the code prior to refactoring (non-refactored code) and a second style of code (e.g., “for” loops) in the refactored code. A machine learning model is then trained to perform code refactoring in a reverse direction of the single directional code transform using the parallel corpora. For example, the machine learning model is trained to transform the “for” loops (second style of code) into dictionary comprehensions (first style of code). In one embodiment, the machine learning model (e.g., neural network model) is trained to perform such transformations by training the machine learning model to predict the masked tokens and/or lines of code in the reverse direction of the single directional code transform. After training the machine learning model to perform code refactoring in a reverse direction of the single directional code transform, new computer code is refactored using the trained machine learning model, where the refactored code now includes a desired style of code (e.g., dictionary comprehensions). In this manner, desired styles that are difficult for refactoring tools to generate when refactoring code can now be generated when refactoring code.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

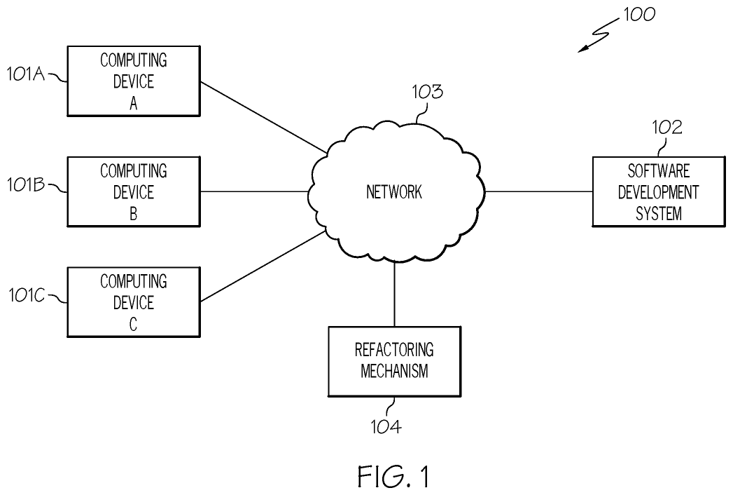

Referring now to the Figures in detail, FIG. 1 illustrates an embodiment of the present disclosure of a communication system 100 for practicing the principles of the present disclosure. Communication system 100 includes computing devices 101A-101C (identified as “Computing Device A,” “Computing Device B,” and “Computing Device C,” respectively, in FIG. 1) connected to a software development system 102 via a network 103. Computing devices 101A-101C may collectively or individually be referred to as computing devices 101 or computing device 101, respectively.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 101 and software development system 102. It is noted that both computing device 101 and the user of computing device 101 may be identified with element number 101.

Software development system 102 is a system utilized, such as by software programmers and software developers (e.g., users of computing devices 101), in the process of creating, designing, deploying and supporting software. Examples of such software development systems, include, but not limited to, RAD Studio®, Embold®, Collaborator®, Studio 3T®, NetBeans®, Zend Studio®, Microsoft® Expression Studio, etc.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 further includes a refactoring mechanism 104 interconnected with computing devices 101 and software development system 102 via network 103. In one embodiment, refactoring mechanism 104 is configured to refactor computer code (also referred to as simply “code”) using a machine learning model (e.g., neural network model). In one embodiment, such a machine learning model is trained to refactor code to a desired style, such as transforming “for” loops to dictionary comprehensions. In one embodiment, such a machine learning model is trained using parallel corpora obtained from a single directional code transform. “Parallel corpora,” as used herein, refers to a collection of code of a first style of code (e.g., dictionary comprehensions) and a second style of code (e.g., “for” loops). In one embodiment, the single directional code transforms are generated using rule-based approaches performed by refactoring tools when refactoring code. The transformations generated by such refactoring tools may not be able to produce desired styles due to the difficulty in generating such desired styles. Since such transformations when refactoring code may restructure the code to include non-desired styles (e.g., “for” loops as opposed to dictionary comprehensions), the principles of the present disclosure train the machine learning model (e.g., neural network model) to refactor code in the reverse direction (e.g., transforming “for” loops to dictionary comprehensions) using the parallel corpora, which includes both styles of code.

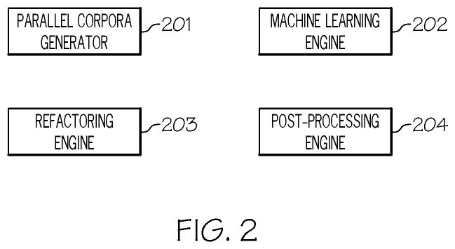

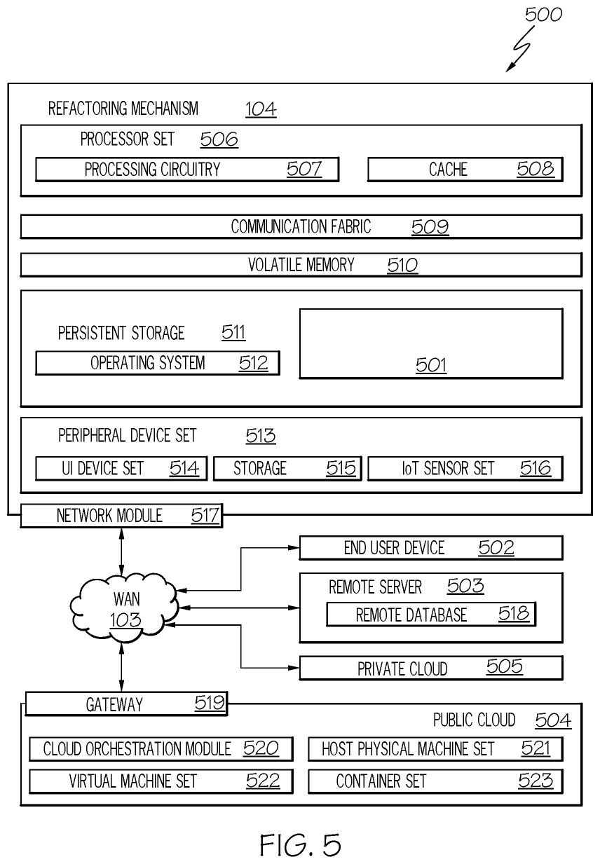

A description of the software components of refactoring mechanism 104 used for refactoring code using a machine learning model to restructure the code to include desired styles (e.g., list comprehensions, dictionary comprehensions, generators, typing annotations, lambda functions, etc.) is provided below in connection with FIG. 2. A description of the hardware configuration of refactoring mechanism 104 is provided further below in connection with FIG. 5.

System 100 is not to be limited in scope to any one particular network architecture. System 100 may include any number of computing devices 101, software development systems 102, networks 103 and refactoring mechanisms 104.

A discussion regarding the software components used by refactoring mechanism 104 to refactor code using a machine learning model to restructure the code to include desired styles is provided below in connection with FIG. 2.

FIG. 2 is a diagram of the software components used by refactoring mechanism 104 (FIG. 1) to refactor code using a machine learning model to restructure the code to include desired styles in accordance with an embodiment of the present disclosure.

As shown in FIG. 2, refactoring mechanism 104 includes a parallel corpora generator 201 configured to generate parallel corpora using a single directional code transform. A “single directional code transform,” as used herein, refers to a transformation performed by a refactoring tool which refactors computer code (“code”) to restructure the code to include styles, which are often undesirable, such as “for” loops, named or defined functions, excluding annotations, etc. In one embodiment, such transformations are performed by refactoring tools using a rules-based approach. For example, a rules-based approach may be to transform dictionary comprehensions (method for transforming one dictionary into another dictionary) to “for” loops (used to repeat a specific block of code a known number of times) in the refactored code. In another example, a rules-based approach may be to transform list comprehensions (syntactic construct available for creating a list based on existing lists) to “for” loops in the refactored code. In a further example, a rules-based approach may be to transform typed annotations (used to indicate the datatypes of variables and input/outputs of functions and methods) to no annotations in the refactored code. In another example, a rules-based approach may be to transform lambda functions (blocks of code that can be assigned to variables, passed as an argument or returned from a function call in languages that support high-order functions) to named or defined functions (relation between a set of inputs having one output each) in the refactored code. Unfortunately, such transformations involve restructuring the code to include undesirable styles (e.g., “for” loops, named functions, no annotations, etc.). Such code is often restructured to include undesirable styles by current refactoring tools due to the ease in restructuring the code to include such undesirable styles.

Examples of refactoring tools to generate single directional code transforms include, but not limited to, Visual Studio Intellicode®, Eclipse® IDE, Spring Tool Suite 4, JetBrains® Rider, IntelliJ® IDEA, SonarQube®, Stepsize, etc.

As discussed above, parallel corpora generator 201 is configured to generate parallel corpora using such single directional code transforms. “Parallel corpora,” as used herein, refers to a collection of code of a first style of code (e.g., dictionary comprehensions) in the code prior to refactoring (non-refactored code) and a second style of code (e.g., “for” loops) in the refactored code. In one embodiment, such parallel corpora is built or generated by parallel corpora generator 201 by forming two non-aligned texts in a common document format, where one document is the translation of the other document. For example, the code prior to refactoring may correspond to a first document and the code after refactoring may correspond to the second document, which is a translation of the code of the first document. Such information is provided to parallel corpora generator 201 by the refactoring tool. In one embodiment, the documents are aligned automatically at the sentence level and processed into a corpus, such as by using Sketch Engine.

In one embodiment, parallel corpora generator 201 is configured to generate parallel corpora using such single directional code transforms by extracting parallel code from parallel documents (code prior to refactoring may correspond to a first document and the code after refactoring may correspond to the second document) provided by the refactoring tool. Parallel code, as used herein, refers to the code that was restructured as well as the same code prior to being restructured. In one embodiment, such parallel code is identified by parallel corpora generator 201 based on identifying modified code between the code prior to refactoring and the code after refactoring. In one embodiment, such parallel code is identified based on identifying the transformations (transform code from a first style to a second style) in the code. In one embodiment, such transformations are identified by parallel corpora generator 201 based on the code style configurations or templates of the refactoring tool, which apply style rules for transforming code during refactoring, including restructuring the code to include undesirable styles (e.g., “for” loops, named functions, no annotations, etc.) as discussed above.

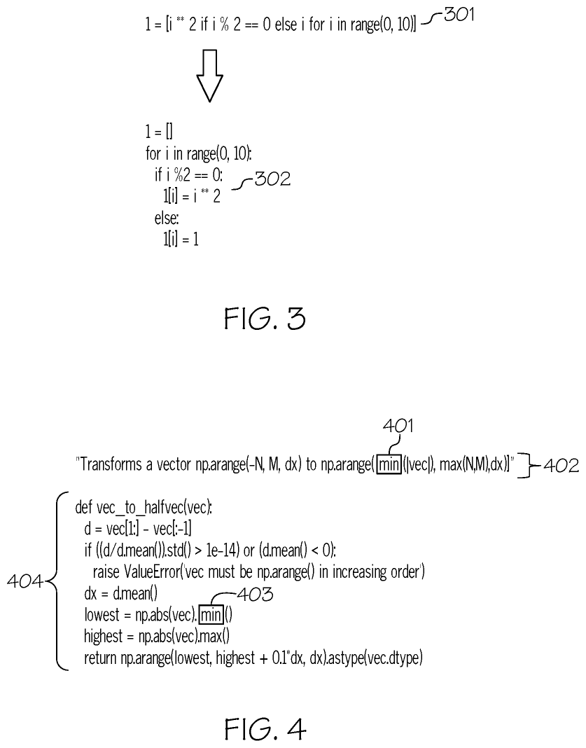

An example of parallel corpora consisting of a list comprehension (a first style) in the code transformed into a “for” loop (a second style) is shown in FIG. 3.

Referring to FIG. 3, FIG. 3 illustrates parallel corpora that consists of a list comprehension 301 (first style) in the code that was transformed into a “for” loop 302 in the refactored code (second style) in accordance with an embodiment of the present disclosure.

A machine learning model will then be trained to perform the transformation in the opposite direction (reverse direction of the single directional code transform). For example, the machine learning model will be trained to transform the “for” loops (second style) (used to repeat a specific block of code a known number of times) into list comprehensions (first style) (syntactic construct available for creating a list based on existing lists). Other examples include training the machine learning model to transform the “for” loops to dictionary comprehensions (method for transforming one dictionary into another dictionary), transform code to utilize generators (routine that can be used to control the iteration behavior of a loop), transform code to utilize typing annotations (used to indicate the datatypes of variables and input/outputs of functions and methods) and transform defined functions (relation between a set of inputs having one output each) to lambda functions (blocks of code that can be assigned to variables, passed as an argument or returned from a function call in languages that support high-order functions).

Returning to FIG. 2, refactoring mechanism 104 further includes a machine learning engine 202 configured to train a machine learning model (e.g., neural network model) to perform code refactoring in a reverse direction of the single directional code transform using the parallel corpora.

In one embodiment, machine learning engine 202 trains the machine learning model (e.g., neural network model) to predict the masked tokens in the reverse direction of the single directional code transform. In one embodiment, the parallel corpora is pre-processed prior to model training to mask words, referred to as “tokens,” in the refactored code that the machine learning model (e.g., neural network model) attempts to identify in the original non-refactored code based on the words surrounding the masked token. A “token,” as used herein, refers to the word, term, symbol, number, etc. in the code. “Masking,” as used herein, refers to excluding code (e.g., token, line of code) that the machine learning model is trained to predict based on the context surrounding the excluded code. “A masked token,” as used herein, refers to the token that is excluded from the training data in which the machine learning model is trained to predict based on the context surrounding the masked token.

Furthermore, in one embodiment, the machine learning model is trained to predict lines of code in the reverse direction of the single directional code transform. For example, a line of code may be masked in the refactored code and the machine learning model is trained to predict such a missing line of code from the training data in the original non-refactored code using the context surrounding the missing line of code.

In one embodiment, machine learning engine 202 utilizes a pre-trained language model, such as CuBERT, for predicting the masked tokens and/or masked lines of code in the non-refactored code based on training data with masked tokens and/or masked lines of code in the refactored code. CuBERT (Code Understanding Bidirectional Encoder Representations from Transformers) is a BERT based model for code understanding.

Another example of a pre-trained language model for predicting the masked tokens and/or masked lines of code in the non-refactored code based on training data with masked tokens and/or masked lines of code in the refactored code is CodeT5, which is a transformer-based model for code understanding and generated based on the T5 architecture. It utilizes an identifier-aware pre-training objective that considers the token type information (identifiers) from the code.

In another example, machine learning engine 202 utilizes the pre-trained language model of OpenAIR Codex to predict the masked tokens and/or masked lines of code in the non-refactored code based on training data with masked tokens and/or masked lines of code in the refactored code. OpenAI® Codex parses natural language, such as the training data, and generates code in response, such as the masked tokens and/or masked lines of code.

An example of a masked token in the refactored code that the machine learning model (e.g., neural network model) is trained to predict in the non-refactored code is shown in FIG. 4.

Referring to FIG. 4, FIG. 4 illustrates a masked token 401 (while “min” 401 is shown in FIG. 4, it is noted that such a token would be excluded from the training data) used in a first style of code 402 of the refactored code that the machine learning model (e.g., neural network model) is trained to predict (see element 403) in a second style of code 404 of the non-refactored code based on the context surrounding masked token 401 in accordance with an embodiment of the present disclosure.

Returning to FIG. 2, in conjunction with FIGS. 3-4, in one embodiment, machine learning engine 202 builds the machine learning model (e.g., neural network model) to predict the masked tokens and/or the masked lines of code in the first style of code (e.g., “for” loops), such as in the refactored code of the parallel corpora, to be used in the second style of code (e.g., list comprehensions) that was used in the non-refactored code of the parallel corpora.

In one embodiment, machine learning engine 202 uses a machine learning algorithm (e.g., supervised learning) to build the machine learning model (e.g., neural network model) to predict the masked tokens and/or the masked lines of code in the first style of code (e.g., “for” loops), such as in the refactored code of the parallel corpora, to be used in the second style of code (e.g., list comprehensions) that was used in the non-refactored code of the parallel corpora using a sample data set containing the parallel corpora.

Such a sample data set is referred to herein as the “training data,” which is used by the machine learning algorithm to make predictions or decisions as to the predicted masked token and/or masked line of code in the first style of code (e.g., “for” loops) to be used in the second style of code (e.g., list comprehensions). The algorithm iteratively makes predictions on the training data as to the predicted masked token and/or masked line of code in the first style of code (e.g., “for” loops) to be used in the second style of code (e.g., list comprehensions) until the predictions achieve the desired accuracy as determined by an expert. Examples of such learning algorithms include nearest neighbor, Naïve Bayes, decision trees, linear regression, support vector machines and neural networks.

In one embodiment, such predictions are analyzed by machine learning engine 202 using an evaluation metric, such as CodeBLEU. Examples of such an analysis include determining whether the machine learning model correctly reconstructed the masked tokens, determining how parsable is the code, determining if the predicted code is syntactically correct in terms of language syntax, determining if the n-grams (contiguous sequence of n items, such as n-terms or n-symbols of code, from the masked token or masked line of code) of the masked token or masked line of code is close to the predicted token or line of code, etc. Based on such an analysis, it may be determined whether the predictions have achieved the desired accuracy.

After such a model is trained, it may be used to perform code refactoring on new computer code by refactoring engine 203 of refactoring mechanism 104, where the refactored code now includes a desired style of code (e.g., dictionary comprehensions). That is, after such a model is trained, refactoring engine 203 of refactoring mechanism 104 performs code refactoring on the new computer code in a reverse direction of the single directional code transform.

In one embodiment, refactoring engine 203 performs such refactoring utilizing the trained machine learning model (e.g., neural network model) by inputting the new computer code into the trained machine learning model. As discussed above, the machine learning model (e.g., neural network model) is trained to perform code refactoring in the reverse direction of the single directional code transform. For example, the single directional code transform may involve transforming the list comprehensions (syntactic construct available in some programming languages for creating a list based on existing lists) to “for” loops (used to repeat a specific block of code a known number of times), transforming dictionary comprehensions (method for transforming one dictionary into another dictionary) to “for” loops, transforming typed annotations (used to indicate the datatypes of variables and input/outputs of functions and methods) to no annotations, transforming lambda functions (blocks of code that can be assigned to variables, passed as an argument or returned from a function call in languages that support high-order functions) to defined or named functions (relation between a set of inputs having one output each), etc. The machine learning model though is trained to perform refactoring in the reverse direction of the single directional code transform, such as transforming the “for” loops into list comprehensions, transforming the “for” loops to dictionary comprehensions, transforming code to utilize generators, transforming code to utilize typing annotations, transforming defined functions to lambda functions, etc.

Refactoring mechanism 104 further includes a post-processing engine 204 configured to perform post-processing of the refactored code (code refactored by the trained machine learning model). Post-processing, as used herein, involves evaluation of the refactored code. In one embodiment, post-processing engine 204 uses an evaluation metric, such as CodeBLEU, to evaluate the refactored code. Examples of such an analysis include determining whether the machine learning model correctly reconstructed the masked tokens, determining how parsable is the code, determining if the predicted code is syntactically correct in terms of language syntax, determining if the n-grams (contiguous sequence of n items, such as n-terms or n-symbols of code, from the masked token or masked line of code) of the masked token or masked line of code is close to the predicted token or line of code, etc. Based on such an analysis, it may be determined whether modifications of the refactored code is required. In one embodiment, the evaluation metric, CodeBLEU, may generate a value, which may be normalized between the values of 0 and 1, indicating whether modifications to the refactored code is required. If such a value exceeds a threshold, which may be user-specified, then such modifications may be implemented.

In one embodiment, such required modification of the refactored code is performed by post-processing engine 204 using symbolic tools, which may manipulate program components, such as via symbolic values, so that the refactored code meets the required modifications. Examples of symbolic tools include, but not limited to, Sublime Text, UltraEdit, Notepad++, TextWrangler, etc.

A further description of these and other features is provided below in connection with the discussion of the method for refactoring code using a machine learning model.

Prior to the discussion of the method for refactoring code using a machine learning model, a description of the hardware configuration of refactoring mechanism 104 (FIG. 1) is provided below in connection with FIG. 5.

Referring now to FIG. 5, in conjunction with FIG. 1, FIG. 5 illustrates an embodiment of the present disclosure of the hardware configuration of refactoring mechanism 104 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code (stored in block 501) involved in performing the disclosed methods, such as refactoring code using a machine learning model. In addition to block 501, computing environment 500 includes, for example, refactoring mechanism 104, network 103, such as a wide area network (WAN), end user device (EUD) 502, remote server 503, public cloud 504, and private cloud 505. In this embodiment, refactoring mechanism 104 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IoT) sensor set 516), and network module 517. Remote server 503 includes remote database 518. Public cloud 504 includes gateway 519, cloud orchestration module 520, host physical machine set 521, virtual machine set 522, and container set 523.

Refactoring mechanism 104 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically refactoring mechanism 104, to keep the presentation as simple as possible. Refactoring mechanism 104 may be located in a cloud, even though it is not shown in a cloud in FIG. 5. On the other hand, refactoring mechanism 104 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto refactoring mechanism 104 to cause a series of operational steps to be performed by processor set 506 of refactoring mechanism 104 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 508 and the other storage media discussed below. The program instructions, and associated data, are accessed by processor set 506 to control and direct performance of the disclosed methods. In computing environment 500, at least some of the instructions for performing the disclosed methods may be stored in block 501 in persistent storage 511.

Communication fabric 509 is the signal conduction paths that allow the various components of refactoring mechanism 104 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In refactoring mechanism 104, the volatile memory 510 is located in a single package and is internal to refactoring mechanism 104, but, alternatively or additionally, the volatile memory may be distributed over multiple packages and/or located externally with respect to refactoring mechanism 104.

Persistent Storage 511 is any form of non-volatile storage for computers that is now known or to be developed in the future. The non-volatility of this storage means that the stored data is maintained regardless of whether power is being supplied to refactoring mechanism 104 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid state storage devices. Operating system 512 may take several forms, such as various known proprietary operating systems or open source Portable Operating System Interface type operating systems that employ a kernel. The code included in block 501 typically includes at least some of the computer code involved in performing the disclosed methods.

Peripheral device set 513 includes the set of peripheral devices of refactoring mechanism 104. Data communication connections between the peripheral devices and the other components of refactoring mechanism 104 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where refactoring mechanism 104 is required to have a large amount of storage (for example, where refactoring mechanism 104 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows refactoring mechanism 104 to communicate with other computers through WAN 103. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the disclosed methods can typically be downloaded to refactoring mechanism 104 from an external computer or external storage device through a network adapter card or network interface included in network module 517.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates refactoring mechanism 104), and may take any of the forms discussed above in connection with refactoring mechanism 104. EUD 502 typically receives helpful and useful data from the operations of refactoring mechanism 104. For example, in a hypothetical case where refactoring mechanism 104 is designed to provide a recommendation to an end user, this recommendation would typically be communicated from network module 517 of refactoring mechanism 104 through WAN 103 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to refactoring mechanism 104. Remote server 503 may be controlled and used by the same entity that operates refactoring mechanism 104. Remote server 503 represents the machine(s) that collect and store helpful and useful data for use by other computers, such as refactoring mechanism 104. For example, in a hypothetical case where refactoring mechanism 104 is designed and programmed to provide a recommendation based on historical data, then this historical data may be provided to refactoring mechanism 104 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

Block 501 further includes the software components discussed above in connection with FIGS. 2-4 to refactor code using a machine learning model. In one embodiment, such components may be implemented in hardware. The functions discussed above performed by such components are not generic computer functions. As a result, refactoring mechanism 104 is a particular machine that is the result of implementing specific, non-generic computer functions.

In one embodiment, the functionality of such software components of refactoring mechanism 104, including the functionality for refactoring code using a machine learning model, may be embodied in an application specific integrated circuit.

As stated above, code refactoring is the process of restructuring existing computer code-changing the factoring-without changing its external behavior. Refactoring is intended to improve the design, structure and/or implementation of the software (its non-functional attributes) while preserving its functionality. Potential advantages of refactoring include improving the code readability and reducing complexity. Furthermore, refactoring may improve the source code's maintainability and create a simpler, cleaner or more expressive internal architecture or object model to improve extensibility. Another potential advantage of refactoring is improved performance. Software engineers face an ongoing challenge to write programs that perform faster or use less memory. Typically, refactoring applies a series of standardized basic micro-refactorings, each of which is usually a tiny change in a computer program's source code that either preserves the behavior of the software or at least does not modify its conformance to functional requirements. Many development environments provide automated support for performing the mechanical aspects of these basic refactorings. If done well, code refactoring may help software developers discover and fix hidden or dormant bugs or vulnerabilities in the system by simplifying the underlying logic and eliminating unnecessary levels of complexity. As computer programming has evolved, certain styles of code have become more desirable than other styles of code, such as due to improving the code readability and reducing complexity. For example, it has become more desirable to use list comprehensions (syntactic construct available for creating a list based on existing lists) or dictionary comprehensions (method for transforming one dictionary into another dictionary) rather than “for” loops (used to repeat a specific block of code a known number of times). In another example, it has become more desirable to use generators (routine that can be used to control the iteration behavior of a loop) for efficient handling of code. In a further example, it has become more desirable to use typing annotations (used to indicate the datatypes of variables and input/outputs of functions and methods), especially in dynamically typed languages (the type of a variable is allowed to change over its lifetime). In another example, it has become more desirable to use lambda functions (blocks of code that can be assigned to variables, passed as an argument or returned from a function call in languages that support high-order functions) instead of defined functions (relation between a set of inputs having one output each). Unfortunately, many of these desired styles are difficult for refactoring tools to generate when refactoring code, especially in dynamically typed languages.

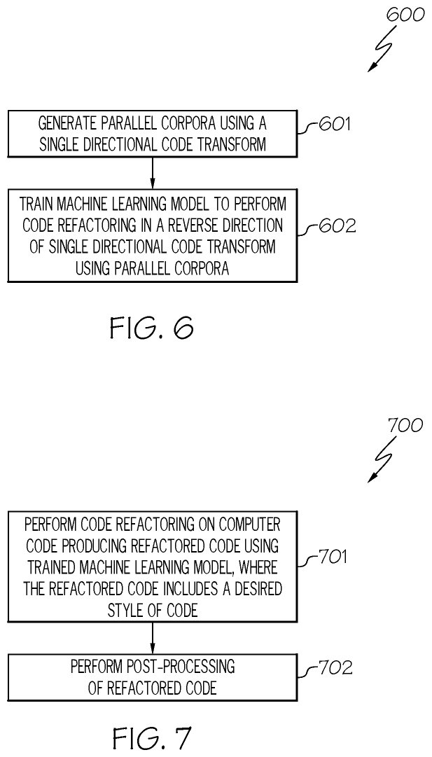

The embodiments of the present disclosure provide a means for generating such desired styles when refactoring code by utilizing a trained machine learning model (e.g., neural network model) to generate such desired styles when refactoring code as discussed below in connection with FIGS. 6-7. FIG. 6 is a flowchart of a method for training a machine learning model to perform code refactoring in a reverse direction of a single directional code transform. FIG. 7 is a flowchart of a method for refactoring code using the trained machine learning model to generate desired styles in the refactored code.

As stated above, FIG. 6 is a flowchart of a method 600 for training a machine learning model to perform code refactoring in a reverse direction of a single directional code transform in accordance with an embodiment of the present disclosure.

Referring to FIG. 6, in conjunction with FIGS. 1-5, in operation 601, parallel corpora generator 201 of refactoring mechanism 104 generates parallel corpora using a single directional code transform.

As discussed above, a “single directional code transform,” as used herein, refers to a transformation performed by a refactoring tool which refactors computer code (“code”) to restructure the code to include styles, which are often undesirable, such as “for” loops, named or defined functions, excluding annotations, etc. In one embodiment, such transformations are performed by refactoring tools using a rules-based approach. For example, a rules-based approach may be to transform dictionary comprehensions (method for transforming one dictionary into another dictionary) to “for” loops (used to repeat a specific block of code a known number of times) in the refactored code. In another example, a rules-based approach may be to transform list comprehensions (syntactic construct available for creating a list based on existing lists) to “for” loops in the refactored code. In a further example, a rules-based approach may be to transform typed annotations (used to indicate the datatypes of variables and input/outputs of functions and methods) to no annotations in the refactored code. In another example, a rules-based approach may be to transform lambda functions (blocks of code that can be assigned to variables, passed as an argument or returned from a function call in languages that support high-order functions) to named or defined functions (relation between a set of inputs having one output each) in the refactored code. Unfortunately, such transformations involve restructuring the code to include undesirable styles (e.g., “for” loops, named functions, no annotations, etc.). Such code is often restructured to include undesirable styles by current refactoring tools due to the ease in restructuring the code to include such undesirable styles.

Examples of refactoring tools to generate single directional code transforms include, but not limited to, Visual Studio Intellicode®, Eclipse® IDE, Spring Tool Suite 4, JetBrains® Rider, IntelliJ® IDEA, SonarQube®, Stepsize, etc.

As also discussed above, parallel corpora generator 201 is configured to generate parallel corpora using such single directional code transforms. “Parallel corpora,” as used herein, refers to a collection of code of a first style of code (e.g., dictionary comprehensions) in the code prior to refactoring (non-refactored code) and a second style of code (e.g., “for” loops) in the refactored code. In one embodiment, such parallel corpora is built or generated by parallel corpora generator 201 by forming two non-aligned texts in a common document format, where one document is the translation of the other document. For example, the code prior to refactoring may correspond to a first document and the code after refactoring may correspond to the second document, which is a translation of the code of the first document. Such information is provided to parallel corpora generator 201 by the refactoring tool. In one embodiment, the documents are aligned automatically at the sentence level and processed into a corpus, such as by using Sketch Engine.

In one embodiment, parallel corpora generator 201 is configured to generate parallel corpora using such single directional code transforms by extracting parallel code from parallel documents (code prior to refactoring may correspond to a first document and the code after refactoring may correspond to the second document) provided by the refactoring tool. Parallel code, as used herein, refers to the code that was restructured as well as the same code prior to being restructured. In one embodiment, such parallel code is identified by parallel corpora generator 201 based on identifying modified code between the code prior to refactoring and the code after refactoring. In one embodiment, such parallel code is identified based on identifying the transformations (transform code from a first style to a second style) in the code. In one embodiment, such transformations are identified by parallel corpora generator 201 based on the code style configurations or templates of the refactoring tool, which apply style rules for transforming code during refactoring, including restructuring the code to include undesirable styles (e.g., “for” loops, named functions, no annotations, etc.) as discussed above.

An example of parallel corpora consisting of a list comprehension (a first style) in the code transformed into a “for” loop (a second style) is shown in FIG. 3.

In operation 602, machine learning engine 202 of refactoring mechanism 104 trains a machine learning model (e.g., neural network model) to perform code refactoring in a reverse direction of the single directional code transform using the parallel corpora. For example, the machine learning model will be trained to transform the “for” loops (second style) (used to repeat a specific block of code a known number of times) into list comprehensions (first style) (syntactic construct available for creating a list based on existing lists). Other examples include training the machine learning model to transform the “for” loops to dictionary comprehensions (method for transforming one dictionary into another dictionary), transform code to utilize generators (routine that can be used to control the iteration behavior of a loop), transform code to utilize typing annotations (used to indicate the datatypes of variables and input/outputs of functions and methods) and transform defined functions (relation between a set of inputs having one output each) to lambda functions (blocks of code that can be assigned to variables, passed as an argument or returned from a function call in languages that support high-order functions).

As stated above, in one embodiment, machine learning engine 202 trains the machine learning model (e.g., neural network model) to predict the masked tokens in the reverse direction of the single directional code transform. In one embodiment, the parallel corpora is pre-processed prior to model training to mask words, referred to as “tokens,” in the refactored code that the machine learning model (e.g., neural network model) attempts to identify in the original non-refactored code based on the words surrounding the masked token. A “token,” as used herein, refers to the word, term, symbol, number, etc. in the code. “Masking,” as used herein, refers to excluding code (e.g., token, line of code) that the machine learning model is trained to predict based on the context surrounding the excluded code. “A masked token,” as used herein, refers to the token that is excluded from the training data in which the machine learning model is trained to predict based on the context surrounding the masked token.

Furthermore, in one embodiment, the machine learning model is trained to predict lines of code in the reverse direction of the single directional code transform. For example, a line of code may be masked in the refactored code and the machine learning model is trained to predict such a missing line of code from the training data in the original non-refactored code using the context surrounding the missing line of code.

In one embodiment, machine learning engine 202 utilizes a pre-trained language model, such as CuBERT, for predicting the masked tokens and/or masked lines of code in the non-refactored code based on training data with masked tokens and/or masked lines of code in the refactored code. CuBERT (Code Understanding Bidirectional Encoder Representations from Transformers) is a BERT based model for code understanding.

Another example of a pre-trained language model for predicting the masked tokens and/or masked lines of code in the non-refactored code based on training data with masked tokens and/or masked lines of code in the refactored code is CodeT5, which is a transformer-based model for code understanding and generated based on the T5 architecture. It utilizes an identifier-aware pre-training objective that considers the token type information (identifiers) from the code.

In another example, machine learning engine 202 utilizes the pre-trained language model of OpenAIR Codex to predict the masked tokens and/or masked lines of code in the non-refactored code based on training data with masked tokens and/or masked lines of code in the refactored code. OpenAI® Codex parses natural language, such as the training data, and generates code in response, such as the masked tokens and/or masked lines of code.

An example of a masked token in the refactored code that the machine learning model (e.g., neural network model) is trained to predict in the non-refactored code is shown in FIG. 4.

FIG. 4 illustrates a masked token 401 (while “min” 401 is shown in FIG. 4, it is noted that such a token would be excluded from the training data) used in a first style of code 402 of the refactored code that the machine learning model (e.g., neural network model) is trained to predict (see element 403) in a second style of code 404 of the non-refactored code based on the context surrounding masked token 401 in accordance with an embodiment of the present disclosure.

In one embodiment, machine learning engine 202 builds the machine learning model (e.g., neural network model) to predict the masked tokens and/or the masked lines of code in the first style of code (e.g., “for” loops), such as in the refactored code of the parallel corpora, to be used in the second style of code (e.g., list comprehensions) that was used in the non-refactored code of the parallel corpora.

In one embodiment, machine learning engine 202 uses a machine learning algorithm (e.g., supervised learning) to build the machine learning model (e.g., neural network model) to predict the masked tokens and/or the masked lines of code in the first style of code (e.g., “for” loops), such as in the refactored code of the parallel corpora, to be used in the second style of code (e.g., list comprehensions) that was used in the non-refactored code of the parallel corpora using a sample data set containing the parallel corpora.

Such a sample data set is referred to herein as the “training data,” which is used by the machine learning algorithm to make predictions or decisions as to the predicted masked token and/or masked line of code in the first style of code (e.g., “for” loops) to be used in the second style of code (e.g., list comprehensions). The algorithm iteratively makes predictions on the training data as to the predicted masked token and/or masked line of code in the first style of code (e.g., “for” loops) to be used in the second style of code (e.g., list comprehensions) until the predictions achieve the desired accuracy as determined by an expert. Examples of such learning algorithms include nearest neighbor, Naïve Bayes, decision trees, linear regression, support vector machines and neural networks.

In one embodiment, such predictions are analyzed by machine learning engine 202 using an evaluation metric, such as CodeBLEU. Examples of such an analysis include determining whether the machine learning model correctly reconstructed the masked tokens, determining how parsable is the code, determining if the predicted code is syntactically correct in terms of language syntax, determining if the n-grams (contiguous sequence of n items, such as n-terms or n-symbols of code, from the masked token or masked line of code) of the masked token or masked line of code is close to the predicted token or line of code, etc. Based on such an analysis, it may be determined whether the predictions have achieved the desired accuracy.

After training the machine learning model to perform code refactoring in the reverse direction of the single directional code transform, the machine learning model is used to perform code refactoring on new computer code in the reverse direction of the single directional code transform thereby generating desired styles of code (e.g., using lambda functions as opposed to defined functions) in the refactored code as discussed below in connection with FIG. 7.

FIG. 7 is a flowchart of a method 700 for refactoring code using the trained machine learning model to generate desired styles in the refactored code in accordance with an embodiment of the present disclosure.

Referring to FIG. 7, in conjunction with FIGS. 1-6, in operation 701, refactoring engine 203 of refactoring mechanism 104 performs code refactoring on new computer code producing refactored code using the trained machine learning model (e.g., neural network model), where the refactored code now includes a desired style of code (e.g., dictionary comprehensions). That is, refactoring engine 203 of refactoring mechanism 104 performs code refactoring on the new computer code in a reverse direction of the single directional code transform.

As discussed above, in one embodiment, refactoring engine 203 performs such refactoring utilizing the trained machine learning model (e.g., neural network model) by inputting the new computer code into the trained machine learning model. As also discussed above, the machine learning model (e.g., neural network model) is trained to perform code refactoring in the reverse direction of the single directional code transform. For example, the single directional code transform may involve transforming the list comprehensions (syntactic construct available in some programming languages for creating a list based on existing lists) to “for” loops (used to repeat a specific block of code a known number of times), transforming dictionary comprehensions (method for transforming one dictionary into another dictionary) to “for” loops, transforming typed annotations (used to indicate the datatypes of variables and input/outputs of functions and methods) to no annotations, transforming lambda functions (blocks of code that can be assigned to variables, passed as an argument or returned from a function call in languages that support high-order functions) to defined or named functions (relation between a set of inputs having one output each), etc. The machine learning model though is trained to perform refactoring in the reverse direction of the single directional code transform, such as transforming the “for” loops into list comprehensions, transforming the “for” loops to dictionary comprehensions, transforming code to utilize generators, transforming code to utilize typing annotations, transforming defined functions to lambda functions, etc.

In operation 702, post-processing engine 204 of refactoring mechanism 104 performs post-processing of the refactored code.

As stated above, post-processing, as used herein, involves evaluation of the refactored code. In one embodiment, post-processing engine 204 uses an evaluation metric, such as CodeBLEU, to evaluate the refactored code. Examples of such an analysis include determining whether the machine learning model correctly reconstructed the masked tokens, determining how parsable is the code, determining if the predicted code is syntactically correct in terms of language syntax, determining if the n-grams (contiguous sequence of n items, such as n-terms or n-symbols of code, from the masked token or masked line of code) of the masked token or masked line of code is close to the predicted token or line of code, etc. Based on such an analysis, it may be determined whether modifications of the refactored code is required. In one embodiment, the evaluation metric, CodeBLEU, may generate a value, which may be normalized between the values of 0 and 1, indicating whether modifications to the refactored code is required. If such a value exceeds a threshold, which may be user-specified, then such modifications may be implemented.

In one embodiment, such required modification of the refactored code is performed by post-processing engine 204 using symbolic tools, which may manipulate program components, such as via symbolic values, so that the refactored code meets the required modifications. Examples of symbolic tools include, but not limited to, Sublime Text, UltraEdit, Notepad++, TextWrangler, etc.

As a result of the foregoing, embodiments of the present disclosure provide a means for generating desired styles when refactoring code by utilizing a trained machine learning model (e.g., neural network model) to generate such desired styles when refactoring code.

Furthermore, the principles of the present disclosure improve the technology or technical field involving code refactoring. As discussed above, code refactoring is the process of restructuring existing computer code-changing the factoring-without changing its external behavior. Refactoring is intended to improve the design, structure and/or implementation of the software (its non-functional attributes) while preserving its functionality. Potential advantages of refactoring include improving the code readability and reducing complexity. Furthermore, refactoring may improve the source code's maintainability and create a simpler, cleaner or more expressive internal architecture or object model to improve extensibility. Another potential advantage of refactoring is improved performance. Software engineers face an ongoing challenge to write programs that perform faster or use less memory. Typically, refactoring applies a series of standardized basic micro-refactorings, each of which is usually a tiny change in a computer program's source code that either preserves the behavior of the software or at least does not modify its conformance to functional requirements. Many development environments provide automated support for performing the mechanical aspects of these basic refactorings. If done well, code refactoring may help software developers discover and fix hidden or dormant bugs or vulnerabilities in the system by simplifying the underlying logic and eliminating unnecessary levels of complexity. As computer programming has evolved, certain styles of code have become more desirable than other styles of code, such as due to improving the code readability and reducing complexity. For example, it has become more desirable to use list comprehensions (syntactic construct available for creating a list based on existing lists) or dictionary comprehensions (method for transforming one dictionary into another dictionary) rather than “for” loops (used to repeat a specific block of code a known number of times). In another example, it has become more desirable to use generators (routine that can be used to control the iteration behavior of a loop) for efficient handling of code. In a further example, it has become more desirable to use typing annotations (used to indicate the datatypes of variables and input/outputs of functions and methods), especially in dynamically typed languages (the type of a variable is allowed to change over its lifetime). In another example, it has become more desirable to use lambda functions (blocks of code that can be assigned to variables, passed as an argument or returned from a function call in languages that support high-order functions) instead of defined functions (relation between a set of inputs having one output each). Unfortunately, many of these desired styles are difficult for refactoring tools to generate when refactoring code, especially in dynamically typed languages.

Embodiments of the present disclosure improve such technology by generating parallel corpora using a single directional code transform. A “single directional code transform,” as used herein, refers to a transformation performed by a refactoring tool which refactors computer code (“code”) to restructure the code to include styles, which are often undesirable, such as “for” loops, named or defined functions, excluding annotations, etc. Such code is often restructured to include undesirable styles by current refactoring tools due to the ease in restructuring the code to include such undesirable styles. “Parallel corpora,” as used herein, refers to a collection of code of a first style of code (e.g., dictionary comprehensions) in the code prior to refactoring (non-refactored code) and a second style of code (e.g., “for” loops) in the refactored code. A machine learning model is then trained to perform code refactoring in a reverse direction of the single directional code transform using the parallel corpora. For example, the machine learning model is trained to transform the “for” loops (second style of code) into dictionary comprehensions (first style of code). In one embodiment, the machine learning model (e.g., neural network model) is trained to perform such transformations by training the machine learning model to predict the masked tokens and/or lines of code in the reverse direction of the single directional code transform. After training the machine learning model to perform code refactoring in a reverse direction of the single directional code transform, new computer code is refactored using the trained machine learning model, where the refactored code now includes a desired style of code (e.g., dictionary comprehensions). In this manner, desired styles that are difficult for refactoring tools to generate when refactoring code can now be generated when refactoring code. Furthermore, in this manner, there is an improvement in the technical field involving code refactoring.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for refactoring code using a machine learning model, the method comprising:
generating parallel corpora using a single directional code transform, wherein the parallel corpora contains a collection of code of a first style of code and translation of the collection of code of the first style of code into a second style of code;
training the machine learning model to perform code refactoring in a reverse direction of the single directional code transform using the parallel corpora; and
performing code refactoring on computer code producing refactored code using the trained machine learning model.

2. The method as recited in claim 1 further comprising:
performing post-processing of the refactored code.

3. The method as recited in claim 2, wherein the post-processing is performed using symbolic tools.

4. The method as recited in claim 1, wherein the single directional code transform comprises one or more of the following in the group consisting of: transforming list comprehensions or dictionary comprehensions to for loops, transforming typed annotations to no annotations, and transforming lambda functions to named functions.

5. The method as recited in claim 1, wherein the machine learning model is trained to perform code refactoring in the reverse direction of the single directional code transform comprising one or more of the following in the group consisting of: transforming for loops to list comprehensions or dictionary comprehensions, transforming code to utilize generators, transforming code to utilize typing annotations, and transforming defined functions to lambda functions.

6. The method as recited in claim 1, wherein the training of the machine learning model to perform code refactoring in the reverse direction of the single directional code transform comprises:
training the machine learning model to predict one or more of the following in the group consisting of: masked tokens and masked lines of code.

7. The method as recited in claim 1, wherein the machine learning model comprises a neural network model.

8. A computer program product for refactoring code using a machine learning model, the computer program product comprising one or more computer readable storage mediums having program code embodied therewith, the program code comprising programming instructions for:
generating parallel corpora using a single directional code transform, wherein the parallel corpora contains a collection of code of a first style of code and translation of the collection of code of the first style of code into a second style of code;
training the machine learning model to perform code refactoring in a reverse direction of the single directional code transform using the parallel corpora; and
performing code refactoring on computer code producing refactored code using the trained machine learning model.

9. The computer program product as recited in claim 8, wherein the program code further comprises the programming instructions for:
performing post-processing of the refactored code.

10. The computer program product as recited in claim 9, wherein the post-processing is performed using symbolic tools.

11. The computer program product as recited in claim 8, wherein the single directional code transform comprises one or more of the following in the group consisting of: transforming list comprehensions or dictionary comprehensions to for loops, transforming typed annotations to no annotations, and transforming lambda functions to named functions.

12. The computer program product as recited in claim 8, wherein the machine learning model is trained to perform code refactoring in the reverse direction of the single directional code transform comprising one or more of the following in the group consisting of: transforming for loops to list comprehensions or dictionary comprehensions, transforming code to utilize generators, transforming code to utilize typing annotations, and transforming defined functions to lambda functions.

13. The computer program product as recited in claim 8, wherein the programming instructions for training the machine learning model to perform code refactoring in the reverse direction of the single directional code transform comprises:
training the machine learning model to predict one or more of the following in the group consisting of: masked tokens and masked lines of code.

14. The computer program product as recited in claim 8, wherein the machine learning model comprises a neural network model.

15. A system, comprising:
a memory for storing a computer program for refactoring code using a machine learning model; and
a processor connected to the memory, wherein the processor is configured to execute program instructions of the computer program comprising:
generating parallel corpora using a single directional code transform, wherein the parallel corpora contains a collection of code of a first style of code and translation of the collection of code of the first style of code into a second style of code;
training the machine learning model to perform code refactoring in a reverse direction of the single directional code transform using the parallel corpora; and
performing code refactoring on computer code producing refactored code using the trained machine learning model.

16. The system as recited in claim 15, wherein the program instructions of the computer program further comprise:
performing post-processing of the refactored code.

17. The system as recited in claim 16, wherein the post-processing is performed using symbolic tools.

18. The system as recited in claim 15, wherein the single directional code transform comprises one or more of the following in the group consisting of: transforming list comprehensions or dictionary comprehensions to for loops, transforming typed annotations to no annotations, and transforming lambda functions to named functions.

19. The system as recited in claim 15, wherein the machine learning model is trained to perform code refactoring in the reverse direction of the single directional code transform comprising one or more of the following in the group consisting of: transforming for loops to list comprehensions or dictionary comprehensions, transforming code to utilize generators, transforming code to utilize typing annotations, and transforming defined functions to lambda functions.

20. The system as recited in claim 15, wherein the program instructions of the computer program for training the machine learning model to perform code refactoring in the reverse direction of the single directional code transform comprises:
training the machine learning model to predict one or more of the following in the group consisting of: masked tokens and masked lines of code.
